(19) United States
(12) Patent Application Publication
(10) Pub. No.: US 2021/0271459 A1
(43) Pub. Date: Sep. 2, 2021

(54) SERVER-DRIVEN USER INTERFACE PRESENTATION FRAMEWORK FOR DEVICE APPLICATIONS

(71) Applicant: PAYPAL, INC., San Jose, CA (US)

(72) Inventors: Dinesh Damodharan, San Jose, CA (US); Nischitha Thimmappa Gowda Sundaramma, Milpitas, CA (US); Sumit Ranjan, San Jose, CA (US)

(21) Appl. No.: 16/803,940

(22) Filed: Feb. 27, 2020

(51) Int. Cl. G06F 8/38; G06F 8/35; G06F 9/451

(52) U.S. Cl. CPC G06F 8/38; G06F 9/451; G06F 8/35

(57) ABSTRACT

There are provided systems and methods for a server-driven user interface presentation framework for device applications. A service provider server, such as an electronic transaction processor for device applications, may provide a framework where application developers and other software providers may develop user interfaces for their device-side application that may be hosted and driven to the application on a device by the service provider's server. The framework may include operations for selecting, arranging, and designing frames of a user interface, which may then be composed into a flow that allows navigation between the different frame, for example, to input data or view different information. Once created, a device side software development kit may be implemented with the application, which may be used to fetch data for, and then display, the user interface through the application.

### TECHNICAL FIELD

The present application generally relates to displaying user interfaces in device applications through server-driven data and more particularly to a framework that allows user interface generation and customization that enables the user interface to be deployed on different platforms through the server-driven data.

### BACKGROUND

Users may utilize computing devices to execute certain applications, which may display data to users through one or more user interfaces. Generally, user interface display is driven by device applications, which may fetch static and dynamic data from local or network databases. These device applications then display the data through the user interface of the device application. However, the device components, structure, and overall composition is device platform and/or application specific. For example, different applications and/or different versions of an application for certain device platforms may have different user interface structures, components, and/or other features based on the specific code and features of the application and/or device. Thus, changes to the user interfaces of an application must be customized for the application and/or device platform, thereby requiring changes to multiple different applications depending on where the user interface is deployed. This creates issues with performing software patching of live applications, as well as deploying those patches and changes of user interfaces for different applications and/or device platforms. Thus, additional processes for coding, deployment, and revisions are required when user interfaces are provided through different applications and/or device platforms.

### BRIEF DESCRIPTION OF THE DRAWINGS

FIG. 1 is a block diagram of a networked system suitable for implementing the processes described herein, according to an embodiment;

FIG. 2 is an exemplary system environment where a user device and a server may interact to provide a server-driven user interface experience within a device application, according to an embodiment;

FIG. 3A is a first exemplary interface for dynamically displaying interface data via a server within a device application, according to an embodiment;

FIG. 3B is an exemplary flowchart showing the construction of a server-driven user interface presentation within a device application, according to an embodiment;

FIG. 4 is a flowchart of an exemplary process for a server-driven user interface presentation framework for device applications, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a server-driven user interface presentation framework for device applications. Systems suitable for practicing methods of the present disclosure are also provided.

Applications may be deployed across multiple different applications including different applications for different operating systems and/or device types. For example, an application may be accessible and deployed through iOS™ devices or operating systems, Android™ devices or operating systems, web browsers, wearable computing devices, cars, etc. These applications may include different user interfaces, which may be used to provide data and executable processes to users. In this regard, a service provider, which may provide services to users, application and software developers, and other third-party entities that provide device applications and/or websites and web applications, may provide a framework that allows for generation and customization of user interfaces (UIs) for these applications. These UIs may include interface components and elements that may be organized into the interface by a developer or other entity that constructs and/or maintains the application.

A particular UI may be utilized to process information and/or provide information to users, for example, through one or more pages or frames of the UI. Once a UI is generated, it may be stored server-side, where it may also be updated and changed by the developer. The service provider's framework may also provide additional processes that may be implemented in the developer's application via a software development kit (SDK) that allows for rendering one or more UIs within the application. The SDKs provided by the service provider may be device and/or platform specific, where the UI data stored server-side may be constructed generally by a developer and may be utilized to populate data in the corresponding application on a particular device/platform. When rendering the UI(s) in the application, the SDK may be implemented on the device-side application that retrieves the server-side data from the service provider's server and/or online database and inserts the data into the UI on the application. This allows for a server-driven UI experience of the application on the particular device displaying and rendering the UI to a user.

In some embodiments, the service provider may provide electronic transaction processing to entities, such as users and application developers/third-parties that may wish to process transactions and payments between parties. A third-party may correspond to some entity, such as consumers, merchants, businesses, etc., that may develop and provide an application to users that includes some functionality. This third-party may therefore constitute one or more application software developers that create, code, and maintain the application, where the application provides information and executable processes to users that are associated with functionalities provided by the third-party to the users. When viewing a UI within an application of the third-party, a user may interact with particular transactions and transactional data to provide a payment to another user or the third-party for items or services. Moreover, the user may view other digital account and/or digital wallet information, including a transaction history and other payment information associated with the user's payment instruments and/or digital wallet. The user may also interact with the service provider to establish an account and other information for the user through the third-party's application.

Therefore, a user may pay for one or more transactions using a digital wallet or other account with the online service provider or other transaction processor (e.g., PayPal®) that provides the server-driven UI framework discussed herein. However, other online service providers may also provide a server-driven UI framework and experience, as described herein, to provide other UI experiences through server-driven data in an application. An account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. These accounts may be accessed to determine the user and/or entity data and may also be used by the users to process transactions.

Thus, the online service provider may provide account services to users of the online service provider, which may be used to process electronic transactions. A user wishing to establish the account may first access the online service provider and request establishment of an account. In order to pay for the transaction (e.g., a transfer or payment to another user, merchant, or other entity), the user may also be required to provide user financial or funding source information or may login to an account with the service provider through authentication information and process the transaction using the account. For an application to utilize and provide these services of the service provider, for example, to establish and maintain the account, as well as provide electronic transaction processing through a third-parties application, the service provider and/or third-party may require one or more UIs associated with the service provider. This allows the application to access and render backend data and executable processes of the service provider, as well as allow input of data, navigation between different UIs and data, and processing of data with the service provider and/or third-party.

A UI may correspond to multiple pages or frames, where the frames are navigated to and rendered depending on a flow through the frames of the user interface. The particular flow may therefore correspond to a process or walkthrough of the frames and may render different data as the user manipulates and proceeds through the UI based on user and/or application actions and operations. The UI within the application therefore includes a flow and frames for that flow through the UI, where the flow may also include different sub-flows depending on the particular navigations, requests, and/or data for display within the UI. For example, a sub-flow may navigate to a certain frame of the UI depending on the data input by the user, such as a success or failure of an operation depending on the input data. Moreover, each frame acts as a container for data and operations that are rendered and provided through the UI. Within that container are one or more interface components or fields, where the components may be utilized to render and provide corresponding backend data and executable operations of and/or stored by the service provider. Moreover, certain policies may also dictate the data for the UI and/or flow/sub-flow proceeded through by the UI. For example, in certain countries, different interface elements, operations, and/or data may be provided, or the UI may be otherwise customized.

When generating a server-driven UI for an application with the service provider, a developer of the third-party providing the application may access the service provider and corresponding server-driven UI framework. The developer may then utilize one or more tools and operations to begin generating and constructing a UI using a registry of interface components. These interface components may provide data (e.g., text, images, or other displayable information associated with the service provider, the third-party, and/or a process of one of those entities), fields for data input, navigational elements, and/or executable processes (e.g., requests for some data processing by the service provider and/or third-party). Thus, these granular atomic components allow developers to add (e.g., drag-and-drop, implement code, etc.) specific granular components to the UI in a layout and manner that the developer wishes for the UI to appear, thereby providing a tailored UI appearance. Further, the overall container for the frame (e.g., the structure including the atomic components) may be reusable and changeable, allowing for additional customization of the UI and the flow of the UI through the frames. The interface components may be provided by the service provider's framework through code snippets, selectable data and/or graphics, and/or insertable data or operations to frames of the UI. The developer may therefore use the framework's tools to add components to each frame of the UI, as well as organize the frames into a flow and requisite sub-flows. The developer may also set policies for regions, domains, device platforms, and/or other parameters that cause customization of the UI depending on detecting those parameters.

Once generated, the developer may request the UI be stored by the service provider, such as in one or more databases of the service provider, so that the UI may be rendered by the service provider's servers on different devices and platforms using the stored data. The developer may also update the UI as necessary using the framework, which may cause the stored data to be updated and therefore allow for customizing and updating of the UI without requiring patching of local applications on devices. Moreover, when constructing the UI, the developer may not need to specify that the UI is specific to a certain device platform, such as iOS™, Android™, a mobile device, a desktop or specific operating system, etc. Instead, the developer may create a generalized UI using the framework, components, frames, and flows, which may then be rendered on specific device platform applications based on SDKs provided by the service provider. Thus, the UI generated server-side is agnostic about the particular device display of the UI and provides the general components and data/processes for each component. Instead, SDKs provided by the service provider for the third-party's application(s) provides the functionality to specify the layout and arrangement of the UI within the specific device platform and/or application. This allows the server-side to control the presentation of the UI to users. Further, the service provider may build and generate SDKs for any additional platforms using the components (e.g., hardware or software platforms, such as device types or operating systems, respectively), which may allow the service provider to drive UI presentation to new devices for the third-party without being required to generate, update, and/or patch the third-party's application for UI presentation.

Once a UI is generated, the service provider may store for rendering in the third-party's application on demand by application when executing a process and/or navigating to the UI. Further, in order to render the UI within the application, the service provider may provide one or more software development kits (SDKs) corresponding to device types and/or platforms that may utilize and execute the application. An SDK may correspond to a set of software development tools that may be available in a package for installing on a device and utilizing with an application. SDKs may facilitate creation of applications by providing specific code packages and operations, such as a compiler, software framework, and the like, within a package that is provided by the service provider for use with creation and maintenance of the third-party's application. Thus, software developers may utilize different specific SDKs to implement different functionalities within an application. Generally, SDKs may be specific to a particular hardware platform and/or operating system, such as a mobile device running iOS™ or the like. Thus, the UI stored server-side may be a general UI outlook and configuration, where the SDKs are utilized to render that UI on each different platform. Using the SDKs provided by the service provider allows the developer of the third-party's application to install and provide certain processes of the service provider on device platforms through the third-party's application. These processes include the processes necessary to retrieve and render the UI data from the service provider's servers and databases, and therefore, provide the processes to enable the server-driven UI presentation experience as discussed herein.

Thereafter, a user may utilize a device having a specific platform-type and operating system. The user may execute the third-party's application, and may navigate to one or more user interfaces that are rendered from the service provider's servers. When navigating to the UIs, the SDK may make one or more application programming interface (API) calls to the service provider's systems and UI presentation framework to retrieve the UI data. The service provider's servers may return data for the UI to the device, where the SDK on the device may then render the UI through code provided by the SDK. Thus, the SDK code matches to code with the server-side user interface data in order to render the UI through the application on the device. When rendering the code, the SDK may determine where and how specific frames of the UI are rendered based on the flow. For example, the SDK code may determine how components are rendered by size, alignment, and other spatial parameter, as well as according to the flow of the UI and policies set for the UI. For example, the SDK may be associated with a component registry for the device platform and application and may fetch JavaScript Object Notation (JSON) descriptors for the UI components. Using the device-side component registry, the SDK may then render the UI based on those descriptors.

Since the SDK is specific to the particular platform, the server-side UI data need not be particular to the device platform, and therefore the server-side UI data may be implemented globally across multiple different device platforms. In some embodiments, the UI data for a particular component may be static data, which may be referenced from descriptors to static data in a database or from another resource or application. However, in other embodiments, the data for a component may be dynamic, where a dynamic resource may be required to be called and dynamic data loaded to the component. This may also include external sources, where a tag or other data object may identify the external data source so that the data is fetched when the UI is presented and displayed within the corresponding component. Using the flow and the sub-flows, as well as navigations by the user and input data, the user may navigate through the UI for the application.

For example, the display may include transaction information and interface elements, fields, or options that allow the user to interact with a transaction, such as to enter authentication information and payment details and/or view additional information. These may correspond to services with the service provider that may offered to the user through the third-party application. Another interface element may be dynamically generated, populated, and/or displayed in response to proceeding through frames of the flow. The server of the service provider may therefore control the loading and presentation of the UI on the user's device. Moreover, as data is input by the user through the UI in the application, the data may be submitted to an operation, where a response is provided to the device by the server and an action to move forward through the frame is performed. In this manner, the server-driven UI is only required to be updated on the server, and not within each individual application for a particular device platform. This reduces the need for individual patching of devices. Further utilizing a server-driven UI experience, an application developer only needs to generate a single iteration of a UI, which may be pushed to different device platforms through corresponding SDKs. This allows different application providers to utilize server-driven UIs in their applications without having to generate and update the UI with each individual application and device platform. For example, service providers (e.g., transaction processors, merchants, transportation providers, websites and web browser providers, or any other third-party that may provide services, information, or other data that may be presented through a graphical user interface (GUI)).

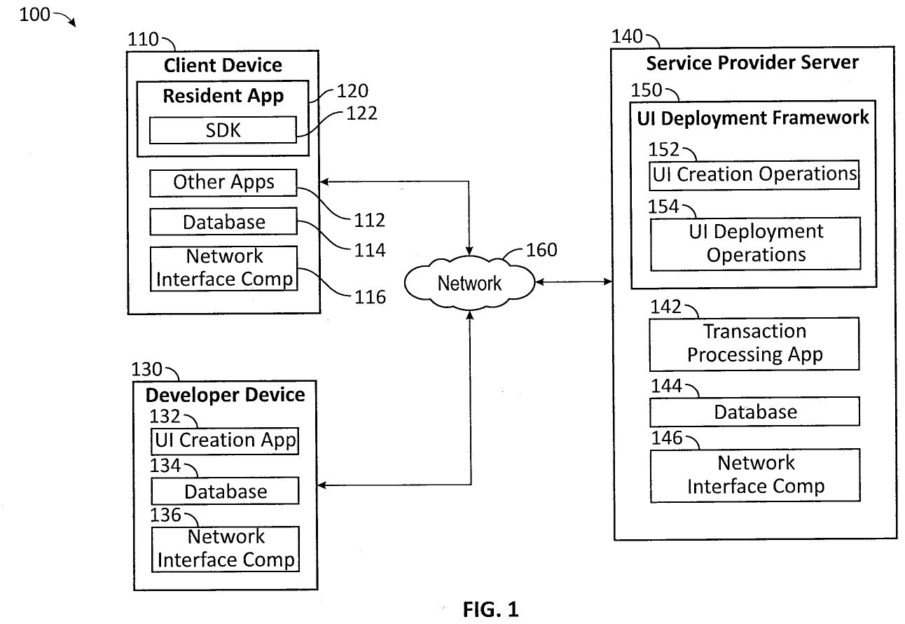

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity

System 100 includes a client device 110, a developer device 130, and a service provider server 140 in communication over a network 160. Client device 110 may be utilized by a user to access a UI via an application, where the interface may be loaded to client device 110 from service provider server 140. In this regard, a developer of an application may utilize developer device 130 to generate the UI with service provider server 140.

Client device 110, developer device 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Client device 110 may be implemented as a communication device that may utilize appropriate hardware and software configured for wired and/or wireless communication with service provider server 140. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains a resident application 120, other applications 112, a database 116, and a network interface component 118. Resident application 120 and other applications 112 may correspond to executable processes, procedures, and/or applications with associated hardware. In other embodiments, client device 110 may include additional or different modules having specialized hardware and/or software as required.

Resident application 120 may correspond to one or more processes to execute software modules and associated components of client device 110 to provide features, services, and other operations for a third-party, such as a third-party associated with developer device 130 that provides resident application 120 executable by client device 110. In this regard, resident application 120 may correspond to specialized hardware and/or software utilized by a user of client device 110 that may be used to access a website or an UI provided by service provider server 140. Resident application 120 may utilize one or more UIs, such as graphical user interfaces presented using an output display device of client device 110, to enable the user associated with client device 110 to enter and/or view data. In some embodiments, the UIs may display transaction data for a transaction (e.g., a payment to another entity, such as a user, merchant, or other payee), provide an account, financial data, or a digital token used to pay for the transaction data, and instruct service provider server 140 to perform transaction processing. In order to do this resident application 120 may render a UI during application execution, where the UI is provided and driven in the application experience and run-time by service provider server 140. To do this, client device 110 includes an SDK 122, which corresponds to a software development kit that implements server-driven UI processes of service provider server 140 on client device 110. Thus, SDK 122 may include executable processes provided by service provider server 140 that are implemented in the third-party's resident application 120.

In some embodiments, resident application 120 may include services for electronic transaction processing provided by service provider server 140, which may be provided through the third-parties resident application 120. During transaction processing, server-driven UIs of resident application 120 may be utilized to select payment instrument(s) for use in providing payment for a purchase transaction, transfer, or other financial process. As discussed herein, resident application 120 may utilize user financial information, such as credit card data, bank account data, or other funding source data, as a payment instrument when providing payment information. Additionally, resident application 120 may utilize a digital wallet associated with an account with a payment provider, such as service provider server 140, as the payment instrument, for example, through accessing a digital wallet or account of a user with service provider server 140 through entry of authentication credentials and/or by providing a data token that allows for processing using the account. Resident application 120 may also be used to receive a receipt or other information based on transaction processing, including transaction data 122 in display 120.

In various embodiments, client device 110 includes other applications 112 as may be desired in particular embodiments to provide features to client device 110. For example, other applications 112 may include security applications for implementing client-side security features, programmatic client applications for interfacing with appropriate application programming interfaces (APIs) over network 160, or other types of applications. Other applications 112 may include device interface applications and other display modules that may receive input from the user and/or output information to the user. For example, other applications 112 may contain software programs, executable by a processor, including a graphical user interface (GUI) configured to provide an interface to the user. Other applications 112 may therefore use components of client device 110, such as display components capable of displaying information to users and other output components, including speakers.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with resident application 120 and/or other applications 112, identifiers associated with hardware of client device 110, or other appropriate identifiers, such as identifiers used for payment/user/device authentication or identification, which may be communicated as identifying the user/client device 110 to service provider server 140. Moreover, database 116 may include UI data when the UI data is provided to client device 110, including frames of a UI and a flow, which may further be determined and displayed based on a policy and SDK 122.

Client device 110 includes at least one network interface component 118 adapted to communicate with service provider server 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Developer device 130 may be implemented as a communication device that may utilize appropriate hardware and software configured for wired and/or wireless communication with service provider server 140. For example, in one embodiment, developer device 130 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Developer device 130 of FIG. 1 contains a UI creation application 132, a database 134, and a network interface component 146. UI creation application 132 may correspond to executable processes, procedures, and/or applications with associated hardware. In other embodiments, developer device 130 may include additional or different modules having specialized hardware and/or software as required.

UI creation application 132 may correspond to one or more processes to execute software modules and associated components of a developer device 130 to provide features, services, and other operations for a developer of a third-party that may correspond to a framework to generate a server-driven UI experience for an application of the third-party. In this regard, UI creation application 132 may correspond to specialized hardware and/or software utilized by a developer to access the framework provided by service provider server 140. UI creation application 132 may view one or more processes to generate a UI, such as by viewing a registry of interface components for a UI, or other data for the components (e.g., code, executable processes, etc.). The developer may arrange one or more components in a container for a frame and may designate a flow through the frames of the UI. UI creation application 132 may utilize the framework to specify any sub-flows that navigate to different frames depending on the particular actions or activities of the application for the third party and the user/device utilizing the application. In some embodiments, the frames and/or flow may be automated based on the same or similar UIs utilized for different applications. For example, the third-party may wish to keep one or more frames or flows the same or similar for different applications provided by that third-party. Thus, the third-party may request automation of frame/flow generation without requiring the developer to perform the UI generation steps. Further, other steps to create a frame and/or flow for a particular UI may also be automated based on machine learning techniques for different applications that allow for automation of the most likely UI generation for a particular application and/or third-party.

Further, the developer may institute policies and provide any data necessary for input to the components of the UI, which may be used to vary the display of the UI depending on certain characteristics and/or parameters of the device executing the application (e.g., country of device or other location, language, user status, device status, etc.). These policies may be provided by the client, the developer, the third-party, and/or learned using machine learning. For example, the policies learned through machine learning may correspond to policies instituted by the same or similar entities for their corresponding applications and/or based on particular client device parameters. Once generated, UI creation application 132 may be used to request storing of the UI, as well as updating of the UI through the framework. UI creation application 132 may also access any SDKs provided by service provider server 140, which may be implemented and integrated with the application of the third-party to display the UI during application run-time. These SDKs may correspond to different device platforms specified by the third-party for execution of the third-party's application that includes the UIs.

Developer device 130 may further include database 134 stored on a transitory and/or non-transitory memory of developer device 130, which may store various applications and data and be utilized during execution of various modules of developer device 130. Database 134 may include, for example, identifiers such as operating system registry entries, cookies associated with UI creation application 132, identifiers associated with hardware of developer device 130, or other appropriate identifiers, such as identifiers used for payment/user/device authentication or identification, which may be communicated as identifying the user/developer device 130 to service provider server 140. Moreover, database 134 may any necessary data for the generation of a UI, including data for components and any code that the developer may integrate with a UI.

Developer device 130 includes at least one network interface component 146 adapted to communicate with service provider server 140. In various embodiments, network interface component 146 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 140 may be maintained, for example, by an online service provider, which may provide server-drive UI experiences through a framework that allows for generating and providing server-driven presentation of UIs on different device platforms. In this regard, service provider server 140 includes one or more processing applications which may be configured to interact with client device 110 and developer device 130 to generate a UI and display the UI on client device 110. In one example, service provider server 140 may be provided by PAYPAL®, Inc. of San Jose, Calif., USA. However, in other embodiments, service provider server 140 may be maintained by or include another type of service provider.

Service provider server 140 of FIG. 1 includes a UI development framework 150, a transaction processing application 142, a database 144, and a network interface component 146. Transaction processing application 142 and other applications 134 may correspond to executable processes, procedures, and/or applications with associated hardware. In other embodiments, service provider server 140 may include additional or different modules having specialized hardware and/or software as required.

UI development framework 150 may correspond to one or more processes to execute modules and associated specialized hardware of service provider server 140 to provide a framework to allow developer device 130 to generate a UI through UI creation operations 152, and further to render the UI on client device 110 during run-time of resident application 120 on client device 110. In this regard, UI development framework 150 may correspond to specialized hardware and/or software used by a user associated with client device 110 to establish a UI by providing operations to generate frames of the UI and organize those frames into a flow that allows navigation between frames of the UI. For example, the flow may present different data through the UI as a user utilizes client device 110 to enter data or perform navigation events and actions. Thus, UI creation operations 152 may be provided to developer device 130 by UI development framework 150 to create the UI for an application. Once the UI is generated and any necessary frames, flows, policies, and/or data is specified for the UI, the UI may be stored on database 144. Thereafter, when resident application 120 executes on client device 110 and requests display of the UI, UI deployment operations 154 may interact with SDK 122 to provide UI data to client device 110. This may be done by matching code for SDK 122 that is utilized to display the application to backend stored data with service provider server 140. UI deployment operations 154 may then provide the data to client device 110, which then renders the data within resident application 120 in a server-driven manner.

Transaction processing application 142 may correspond to one or more processes to execute modules and associated specialized hardware of service provider server 140 to process a transaction, which may be done through the server-driven UI by UI development framework 150. In this regard, transaction processing application 142 may correspond to specialized hardware and/or software used by a user associated with client device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 140. In some embodiments, the financial information may also be used to establish a payment account. The payment account may be accessed and/or used through a browser application and/or dedicated payment application executed by client device 110 and engage in transaction processing through transaction processing application 142, such as resident application 120 that displays UIs from service provider server 140. Transaction processing application 142 may process the payment and may provide a transaction history to client device 110 for transaction authorization, approval, or denial.

Additionally, service provider server 140 includes database 144. Database 144 may store various identifiers associated with client device 110. Database 144 may also store account data, including payment instruments and authentication credentials, as well as transaction processing histories and data for processed transactions. Database 144 may store financial information and tokenization data. Database 144 may further store data necessary for UIs that are generated by third-parties and displayed to users through a third-party application (e.g., resident application 120) that displays server-driven UIs from service provider server 140.

In various embodiments, service provider server 140 includes at least one network interface component 146 adapted to communicate client device 110 and/or developer device 130 over network 160. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

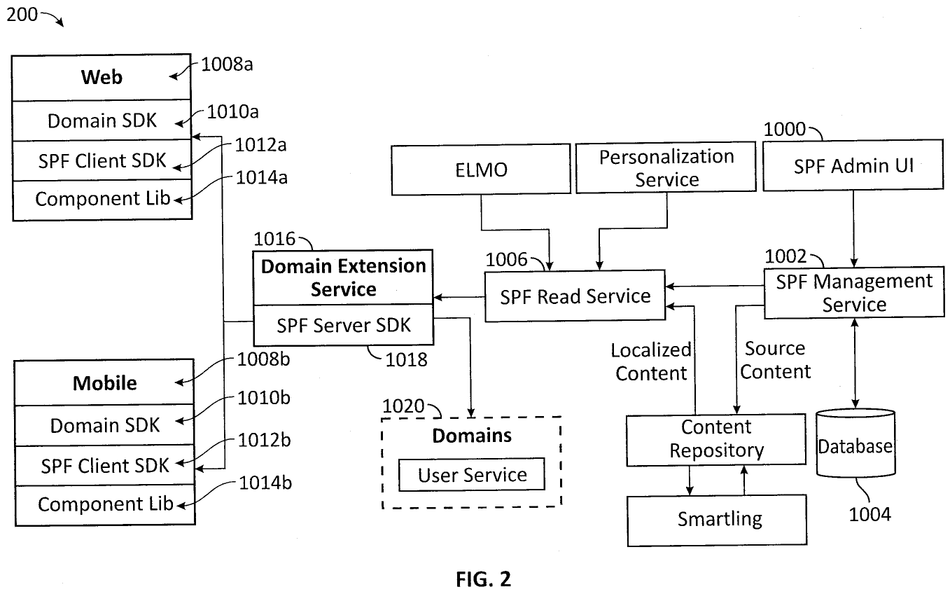

FIG. 2 is an exemplary system environment where a user device and a server may interact to provide a server-driven user interface experience within a device application, according to an embodiment. System 200 of FIG. 2 includes client device 110 and service provider server 140 discussed in reference to system 100 of FIG. 1. In this regard, client device 110 and service provider server 140 may interact to perform a server-driven experience of UI presentation based on local SDKs on the client device. These SDKs may correspond to different device platforms, such as a web platform, native resident application, device-type, or other type of platform that may execute the application having the server-driven UIs.

System 200 displays how a UI may be presented within an application on client device 110 from a server, and further shows the components of the service provider's system necessary for UI generation and establishment with the service provider. Beginning with generating a UI for a server-driven experience, server-driven presentation framework (SPF) admin UI 1000 corresponds to a UI of an administrative tool that may be accessed by a developer for construction of a UI using a registry of components and corresponding data or processes. This allows for building of frames and flows of a UI that may be implemented in the developer's application, such as a third-party application of a third-party service provider. SPF admin UI 1000 is powered by SPF management service 1002, which provides the corresponding tools, operations, and APIs to allow for the developer to generate the UI. When frames, flows, or other data (including metadata) for a UI are saved and stored server-side, database 1004 may be utilized and accessible when presenting those UIs on a device. Thus, SPF admin UI 1000, SPF management service 1002, and database 1004 may correspond to the system that allows for creation and management of UIs. SPF management service 1002 may also provide RESTful APIs to manage flows/frames and components for UIs, for example, Get, Create, Update, Delete.

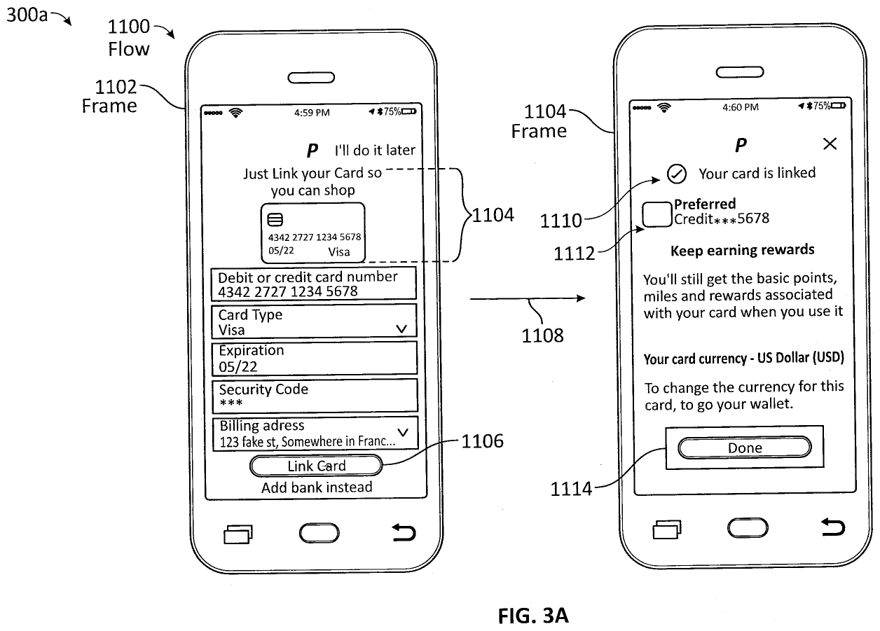

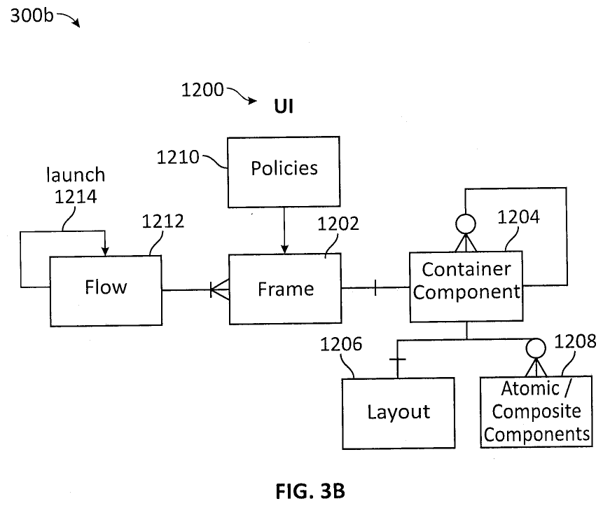

SPF read service 1006 may be deployed in production and built on top of database 1004 to allow for accessing and reading of the flows and frames corresponding to particular UIs. This SPF read service 1006 may be called in application run-time. For example, a user utilizes a device to launch a frame of a UI (e.g., an “add card” frame, such as one shown in FIG. 3B, which may be put together with additional frames into a flow). This may be done through accessing a URL through a web application 1008a or a mobile application 1008b (e.g., a resident application on a mobile device). A domain SDK 1010a or 1010b (e.g., a digital wallet SDK or other SDK for a domain) may be used to internally invoke an SPF client SDK 1012a or 1012b with an internal API call to launch a flow. Thereafter, SPF client SDK 1012a or 1012b may make an API call to a domain extension server 1016 having a SPF server SDK 1018. This call may be the proxied for an API call to SPF read server 1006 to get all the descriptors of the flow and frames (e.g., JSON descriptors stored with a particular UIs flow/frames). These descriptors may therefore correspond to the “add card” flow or other UI flow for the frames of the UI. Further, SPF read service 1006 may expose RESTful APIs to read a SPF flow/frame given the flow/frame identifiers. The flows JSON descriptors may be cached in SPF read service 1006 to reduce latency.

Domains 1020 may determine other components or data substituted into the particular flow. For example, a user service API call of domains 1020 may determine a billing address is required for the “add card” flow. This allows for calls to external resources and data mining that is specific to certain domains associated with domain extension service 1016. Thus, domain extension service 1016 provides the domain specific calls and fetches data for a domain instead of having the SPF read service 1006 be domain specific. Once the particular flow and frames are ready to be consumed and presented on a client device (e.g., through web application 1008a or mobile application 1008b), the flow and frames of the UI are provided to the client device. Additionally, all dynamic placeholders are replaced with the actual values fetched from one or more resources. Thus, the UI is driven from the server to the client when the client navigates to a frame of a UI. The client-side SDKs are then responsible for presenting the frames of the UI based on the flow. The client-side SPF client SDK 1012a or 1012b may then take care of presenting the frames using component library 1014a or 1014b, respectively. These SPF client SDKs 1012a or 1012b therefore takes care of presenting the flow, executing all actions and validations of the flow, and then renders the frame using component library 1014a or 1014b. Component library 1014a or 1014b corresponds to a library that has all the components registered and implemented. Component library 1014a or 1014b corresponds to reusable standardized components that may be used to render data within a frame. However, third parties may also register and present components for UIs.

In some embodiments, additional elements may be utilized in order to provide the server-driven UI. For example, ELMO may correspond to internal system which provides services for experimentation (e.g., Ramp, A/B testing, etc.). In context of the SPF of system 200, ELMO may provide SPF users with the ability to A/B test frames and flows of a UI, as well as and component variations of the UI using ELMO experimentation platform. A personalization service may also correspond to an internal service that provides the ability to personalize a UI experience by showing different variations of UI to different segments of users. This allows users to configure several decision rules for showing a particular variation of a UI to a customer, user, or the like. In context of the SPF in system 200, this provides personalization capabilities in frames/flows. Content service may correspond to an internal service which provides APIs to create and retrieve content. The content stored in source locale (e.g., en_US) may be localized by an automated localization workflow (e.g., Smartling in system 200). Once the localization is complete the target locales (e.g., fr_US) may be retrieved using the GET APIs provided by the content service.

FIG. 3A is a first exemplary interface for dynamically displaying interface data via a server within a device application, according to an embodiment. Environment 300a includes an interface displayed by a device, such as client device 110 in system 100 of FIG. 1. In this regard, the interface may be displayed through a frame 1102 and a frame 1104 that are displayed in an order for a flow 1100.

In frame 1102 of flow 1100 for the interface, a container is shown having a layout of arrangement of atomic components provided by a service provider when generating a server-driven UI for an application. For example, frame 1102 includes a displayable component 1104 and an operational component 1106. Displayable component 1104 may include some text, image, or other displayable data to a user, which may be static or dynamic data. For example, static data may be stored in a database of a service provider or linked to another resource, while dynamic data may be fetched when the UI is presented and may change depending on the underlying data. Components in frame 1002 may also be associated with underlying operations, which include navigations to different frames (e.g., frame 1104 based on flow 1100), entry of input into fields, and/or data processing requests for input data, selections, or other information provided by a user viewing frame 1102. For example, operational component 1106 provides an interface element or component that allows for a request to “add a card” such as through other data entered to the fields shown in frame 1102. Operational component 1106 may correspond to an action trigger that, on-click or selection, is linked to a backend add card and validate card action with the service provider's servers. This allows for validation of all the fields in the form of frame 1102. Thus, the first action may be to validate the data, only after which does flow 1100 proceed to frame 1104. If the card data cannot be validated, a different frame based on the invalid data may be presented for a corresponding sub-flow. If all fields are validated, then the action for operational component 1106 may collect the data in the fields in a schema that is acceptable to the service provider servers and submit the payload to the server for processing. Thereafter, further processes may be implemented on the service provider server to link the card in the fields to an account of the user. Subsequently, when operational component 1106 is selected, a navigation action 1108 may navigate the user interface in environment 300a to frame 1104.

In frame 1104, new interface components are shown in the container for frame 1104. For example, the components are updated based on flow 1100 and any backend processing performed through the entry of data and data processing request (e.g., to add a financial account or payment card to an account with a service provider). Frame 1104 shows a notification component 1110 that may be displayed based on flow 1100 and any sub-flows. In this regard, notification component 1110 may be different depending on the overall success of the data processing performed when operational component 1106 is selected. As shown in frame 1104, notification component 1110 is displayed through a sub-flow that has a completed or success operation based on the data processing (e.g., the payment card was linked to the service provider account). Further, the data entered to informational component 1112 is taken from the previous data input to the fields of frame 1102 and processed when operational component 1106 of frame 1102 is selected. Completion component 1114 further allows additional navigations or other operations within the third-party application and/or associated with the server-driven UI for the application. Frames 1002 and 1104 may be generated by a developer and stored with a service provider so that the service provider may provide the UI in a server-driven experience to users.

FIG. 3B is an exemplary flowchart showing the construction of a server-driven user interface presentation within a device application, according to an embodiment. User interface (UI) 1200 shown in environment 300b may correspond to a UI provided and rendered on devices in a server-driven experience, where the UI is not stored locally to a device and rendered by the application. Instead, the UI is deployed to the device by a server utilizing the components and flow in environment 300b. Thus, the device utilizes a platform-specific SDK within the device application to render the UI from a server of the service provider, where the UI does not need to be required to be device-platform specific. Instead, the SDKs allow for the display of the UI in a device-platform specific manner.

In order to display UI 1200, one or more of frame 1202 may be generated by a developer for an application using a framework provided by a server of a service provider that generates and renders UI 1200 in an application. Frame 1202 includes a container component 1204, which corresponds to the overall container that allows for addition of atomic/composite components 1208. Atomic/composite components 1208 may be provided through a registry by the service provider, where developers may select and add certain components to frame 1202. When organizing the components into frame 1202, a layout 1206 may correspond to the overall arrangement of atomic/component components 1208, such as their location within a two- or three-dimensional space for container component 1204.

Once frame 1202 has been generated using the server-driven framework for UI display on a device, frame 1202 may be organized with other frames into an overall flow 1212. Flow 1212 may further include sub-flows, which allow for navigation to different frames depending on the action taken by a user through a resident application on a client device. Frame 1202 may display certain data and/or flow 1212 may proceed through different sub-flows and/or presentation of frames depending on policies 1210 that are set for UI 1200. For example, policies 1210 may affect the particular output of data depending on a location of the client device, parameter set for the client device, and/or other data. Policies 1210 may manage the outlook and arrangement of atomic/composite components 1208. In this regard, frame 1202 may correspond to a static or general build of a frame of UI 1200. Policies 1210 may then change the data provided in each component, as well as size, arrangement, or location of atomic/composite components 1208 within frame 1202. These policies 1210 may be implemented depending on the particular parameters for the device, device platform, domain, operating system, or other information associated with the display request for UI 1200. Thus, once UI 1200 is accessed through a launch 1214, UI 1200 may proceed through frame 1202 and other frames, with data displayed in those frames, based on policies 1210 and flow 1212.

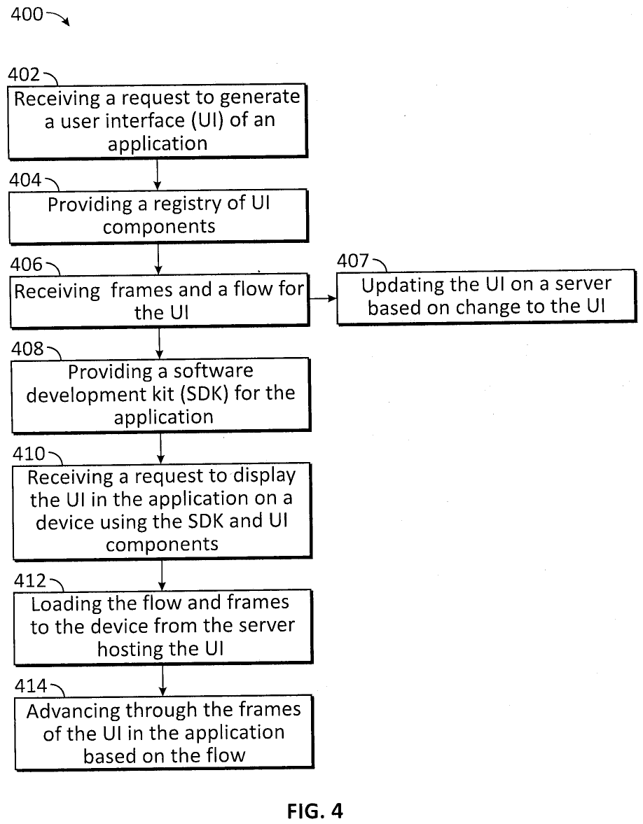

FIG. 4 is a flowchart 400 of an exemplary process for a server-driven user interface presentation framework for device applications, according to an embodiment. Note that one or more steps, processes, and methods described herein of flowchart 400 may be omitted, performed in a different sequence, or combined as desired or appropriate.

At step 402 of flowchart 400, a request to generate a user interface (UI) of an application is received. The request may be received from a device of a developer, such as when the developer accesses a framework provided by a service provider. The framework may allow for construction of UIs through operations of the framework, which may allow the developer to view the container for individual frames of a UI and organize those frames into a flow. Thus, a registry of UI components is provided, at step 404, to the developer. The developer may then select from these UI components, or add code corresponding to these or other UI components, to the particular container for a frame. The container therefore allows for construction of an individual frame for a UI by allowing arrangement and composure of the frame from the interface components. The frames are therefore received from a flow of the UI, at step 406. Once one or more frames is constructed using the registry, the flow of the UI may then be designated, including any necessary sub-flows for the UI. These sub-flows allow for navigation between different frames depending on the execution of the corresponding underlying application, as well as input of data from a user to one or more fields of the UI.

In some embodiments, at step 407, once the UI is constructed and a flow arranged for the navigation between frames, the UI may be updated on a server for the service provider providing server-driven UI experiences based on changes by the developer or other entity to the UI. For example, after the UI is set, the third-party may want to institute changes, which are reflected across all device platforms displaying the UI through the third-party's application. This may be done by updating the UI data on the server without having to patch each individual device platform's version of the application. Once the UI is set, updated, and/or stored, the service provider having the server-driven presentation framework may provide one or more software development kits (SDKs) for the third party's application(s) executable by different device platforms, at step 408. The SDKs allow for implementation of the UI within the third-party's application by the developer. Thus, the SDKs include operations and code that allow for retrieving and rendering UI data within the application.

Once the SDKs have been integrated with the third-party's application to allow for server-driven presentation of the UI on different device platforms for the application, at step 410, a request to display the UI in the application on a device using the SDK and interface components registry is received. This may be received when the third-party's application is opened and executed, and when the application navigates to the particular UI. The application may then perform one or more API calls to a server of the service provider that request the UI from the server. At step 412, the flow and frames are loaded to the device from the server hosting the UI. This may be performed using a system for the service provider and interactions between devices, such as those shown and described in system 200 of FIG. 2. For example, a management service may be used to retrieve data for the UI from a database, where the data may be read by a read service and provided to a server of the service provider. The server may then provide the data to the particular platform's application that requests to display the UI. Thereafter, at step 414, the device may advance through the frames of the UI in the application based on the flow. Further, the frames may be advanced depending on input to component fields, selection of certain operational components and/or navigational components, or other action taken within the application. This allows for different sub-flows of the UI to proceed through based on the activities of the user with the application.

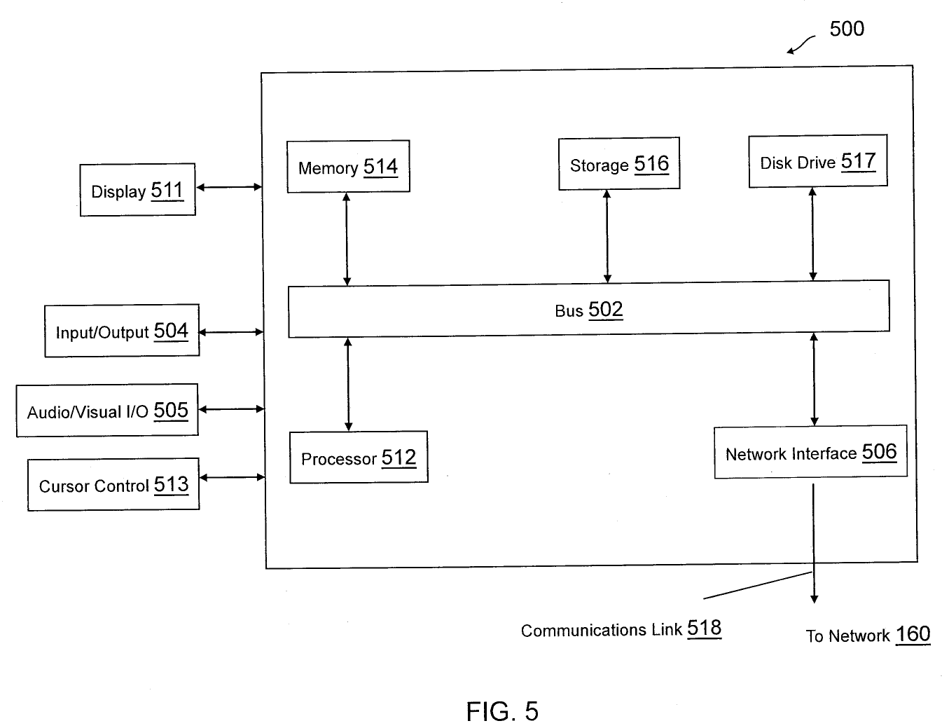

FIG. 5 is a block diagram of a computer system suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a non-transitory memory; and
one or more hardware processors coupled to the non-transitory memory and configured to read instructions from the non-transitory memory to cause the system to perform operations comprising:
receiving a navigation to an interface of an application executing on the system;
determining an interface flow between a plurality of frames of the interface, wherein the interface flow comprises a plurality of sub-flows based on different user inputs in a first frame of the plurality of frames and one or more policies associated with the different user inputs;
determining the first frame of the plurality of frames to display based in the navigation and the interface flow, wherein the first frame comprises a layout of at least one interface component and interface data to display within the at least one interface component, and wherein the at least one interface component comprises an interface field;
determining that the interface data comprises a data object for dynamic data from an external resource;
determining the dynamic data from the external resource at a time of the navigation to the interface of the application;
loading the first frame of the interface into the application based on the interface data, wherein the loading of the first frame causes the interface data to be displayed within the at least one interface component in the interface of the application, and wherein the data object enables a display of the dynamic data within the first frame based on the external resource;
receiving a first user input to the application via the interface field in the first frame of the interface;
determining a first sub-flow of the plurality of sub-flows based on the first user input and the one or more policies; and
changing the interface flow based on the first sub-flow.

2. The system of claim 1, wherein prior to the determining the interface flow, the operations further comprise:
requesting data for the interface flow from a server of a service provider, wherein the data is associated with the application and a software development kit (SDK) for retrieval and display of the interface within the application based on the data; and
receiving the data from the server.

3. The system of claim 1, wherein the operations further comprise:
receiving a further navigation to a second frame of the plurality of frames; and
advancing the interface to the second frame based on the further navigation and the changed interface flow.

4. The system of claim 3, wherein the further navigation comprises at least one of a second user input to the at least one interface component or an activation of one interface component from the at least one interface component.

5. The system of claim 1, wherein the plurality of frames and the interface flow for the interface are generated by a server and received by the system on behalf of an entity providing the application to the system.

6. The system of claim 1, wherein the operations further comprise:
receiving the one or more policies to display the interface data; and
determining one of the one or more policies based on a parameter of the system.

7. The system of claim 6, wherein the parameter of the system comprises one of a location of the system, a type of the application on the system, or a domain associated with the at least one interface component.

8. The system of claim 1, wherein the at least one interface component is based on a registry of interface components for a device type of the system.

9. The system of claim 1, wherein the at least one interface component comprises a process for a service provider associated with the interface within the application, and wherein the process comprises one of an account registration process, an electronic transaction processing process, or an account login process.

10. The system of claim 9, wherein the process is linked to a data processing operation with a server of the service provider.

11. A method comprising:
receiving a request to generate an interface for an application;
providing a registry of interface components for the interface;
receiving a first layout of a first frame of the interface that comprises at least one first interface component from the registry of the interface components, wherein the first layout comprises a first structure of the interface for the first frame, and wherein the at least one first interface component comprises an interface field;
generating the first frame based on the first layout;
receiving a flow to a second frame of the interface, wherein the flow navigates from the first frame to the second frame, and wherein the flow comprises a plurality of sub-flows based on different user inputs in the first frame and one or more policies associated with the different user inputs;
determining that the interface comprises a data object for dynamic data from an external resource;
determining the dynamic data from the external resource at a time of the request to generate the interface of the application;
receiving a first selection of a user input from the different user inputs for the interface field in the first frame of the interface;
receiving a second selection of a sub-flow of the plurality of sub-flows based on the user input and the one or more policies; and
generating the interface based on the first frame, the flow, the sub-flow, the second frame, and the dynamic data.

12. The method of claim 11, wherein the at least one first interface component is displayed within a container for the first frame based on the first structure.

13. The method of claim 11, wherein prior to the generating the interface, the method further comprises:
receiving a second layout of the second frame of the interface that comprises at least one second interface component from the registry of the interface components; and
generating the second frame based on the second layout.

14. The method of claim 11, wherein the at least one first interface component comprises a process for the application that is executable through the interface, and wherein the process comprises the interface field for entry of the user input to an operation of a service provider associated with the interface.

15. The method of claim 11, wherein prior to receiving the request to generate the interface, the method further comprises:
providing a software development kit (SDK) to an entity associated with the application, wherein the SDK provides functionality of a service provider within the application.

16. The method of claim 15, wherein the SDK is further associated with a component library for the application that provides the at least one first interface component on a device displaying the interface.

17. The method of claim 11, wherein the interface is generated by service provider server, and wherein the method further comprises:
loading interface data for the interface to a device having the application that utilizes the interface.

18. A non-transitory machine-readable medium having stored thereon machine-readable instructions executable to cause a machine to perform operations comprising:
receiving, by a computing device, interface data for an interface of an application on the computing device from a server of a service provider, wherein the interface data comprises a flow between a plurality of frames of the interface that is displayable using a software development kit (SDK) on the computing device for the application, and wherein the flow comprises a plurality of sub-flows based on different user inputs in at least one of the plurality of frames and one or more policies associated with the different user inputs;
receiving a request to display the interface data during a use of the application;
determining that the interface data comprises a data object for dynamic data from an external resource;
determining the dynamic data from the external resource at a time of a navigation to the interface of the application;
rendering the interface data within the application using the SDK and the dynamic data, wherein the interface data comprises an interface field within the application;
receiving a user input to the application via the interface field;
determining a sub-flow of the plurality of sub-flows based on the user input and the one or more policies; and
changing the flow based on the sub-flow.

19. The non-transitory machine-readable medium of claim 18, wherein the interface comprises a payment interface having a plurality of components associated with the service provider, and wherein each of the plurality of components display, within the interface of the application, one of displayable data or a service provider process associated with at least one of the application or the service provider.

20. The non-transitory machine-readable medium of claim 19, wherein the interface data is received from the server of the service provider, and wherein the interface data further comprises a plurality of policies associated with display of data within the plurality of components based on a parameter of the computing device.
